(19) United States
(12) Patent Application Publication
(10) Pub. No.: US 2014/0051048 A1
(43) Pub. Date: Feb. 20, 2014

(54) OSTOMY LEARNING ASSEMBLIES, KITS, AND METHODS OF MAKING AND USING

(71) Applicant: Cara Jean Wooldridge, Port Orchard, WA (US)

(72) Inventor: Cara Jean Wooldridge, Port Orchard, WA (US)

(21) Appl. No.: 13/797,713

(22) Filed: Mar. 12, 2013

Related U.S. Application Data
(60) Provisional application No. 61/640,523, filed on Apr. 30, 2012.

(51) Int. Cl. G09B 23/30

(52) U.S. Cl. CPC G09B 23/30
USPC 434/267

(57) ABSTRACT

An ostomy learning assembly generally includes a body attachment device, and an artificial stoma couplable to the body attachment device.

### CROSS-REFERENCE TO RELATED APPLICATION

This application claims the benefit of U.S. Provisional Application No. 61/640,523, filed Apr. 30, 2012, the disclosure of which is herein incorporated by reference in its entirety.

### BACKGROUND

In an ostomy procedure, for example, a colostomy, an ileostomy, or a urostomy, an opening is surgically created in the body for the discharge of body waste. In a colostomy procedure, a portion of the colon or the rectum is removed and the remaining colon (large intestine) is brought through the abdominal wall to form a stoma extending from the patient's skin. An ileostomy involves a portion of the small intestine, usually at the end of the ileum, and a urostomy is a urinary diversion. Ostomies may be temporary or permanent surgeries, and may involve removal of all or part of the ureter or colon.

The stoma is the actual end of the ureter or colon that can be seen protruding through the patient's skin, fixed as a small “rose” shaped bud. The stoma can sit flush with the patient's skin or it may protrude up to several inches from the patient's body.

After the surgery, body waste discharged from the stoma is typically collected in an ostomy appliance or bag that can be attached to the patient's stoma. Regardless of whether the ostomy is temporary or permanent, appliance use and care can be complicated, and sometimes humiliating, for patients and caregivers. Required skills of ostomy appliance care include placing or exchanging the wafer or base plate for the bag, emptying the bag, and cleaning and or burping the bag without a mess.

Therefore, there exists a need for an ostomy learning assembly for teaching patients, doctors, nurses, and caregivers stoma and ostomy appliance care.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an ostomy learning assembly is provided. The assembly generally includes a body attachment device, and an artificial stoma couplable to the body attachment device.

In accordance with another embodiment of the present disclosure, a kit for making an ostomy learning assembly is provided. The kit generally includes a body attachment device, and an artificial stoma including a base and a cover that is configurable by a user to approximate the actual or predicted dimensions of a surgically created stoma, wherein the artificial stoma is attachable to the body attachment device.

In accordance with another embodiment of the present disclosure, a method of practicing attaching an ostomy appliance to an artificial stoma is provided. The method generally includes obtaining an ostomy learning assembly including a body attachment device and an artificial stoma, attaching the body attachment device to the body of the user, positioning the artificial stoma in the approximate location of a real stoma, and attaching the ostomy appliance to the artificial stoma.

In accordance with another embodiment of the present disclosure, a method of making an artificial stoma is provided. The method generally includes obtaining a balloon having a closed end and an open end, obtaining a piece of foam piping having a center hole, inserting the piping into the open end of the balloon, making a hole in the closed end of the balloon, and inverting the open end of the balloon and feeding it through the center hole of the piping and through the hole in the closed end of the balloon.

### DESCRIPTION OF THE DRAWINGS

The foregoing aspects and many of the attendant advantages of this disclosure will become more readily appreciated by reference to the following detailed description, when taken in conjunction with the accompanying drawings, wherein:

FIG. 1 is an isometric front view of an ostomy learning assembly in accordance with one embodiment of the present disclosure;

FIG. 2 is an isometric back view of the ostomy learning assembly of FIG. 1;

FIG. 3A is an exploded view of the ostomy learning assembly of FIG. 1;

FIG. 3B is a close-up, partial, exploded view of the ostomy learning assembly of FIG. 1;

FIGS. 4-9 are a sequence of isometric views of the ostomy learning assembly of FIG. 1 in the process of being attached, worn, and/or used by a user.

### DETAILED DESCRIPTION

The detailed description set forth below in connection with the appended drawings where like numerals reference like elements is intended as a description of an embodiment of the disclosed subject matter and is not intended to represent the only embodiment. The embodiments described in this disclosure are provided merely as examples or illustrations and should not be construed as preferred or advantageous over other embodiments. The illustrative examples provided herein are not intended to be exhaustive or to limit the claimed subject matter to the precise forms disclosed.

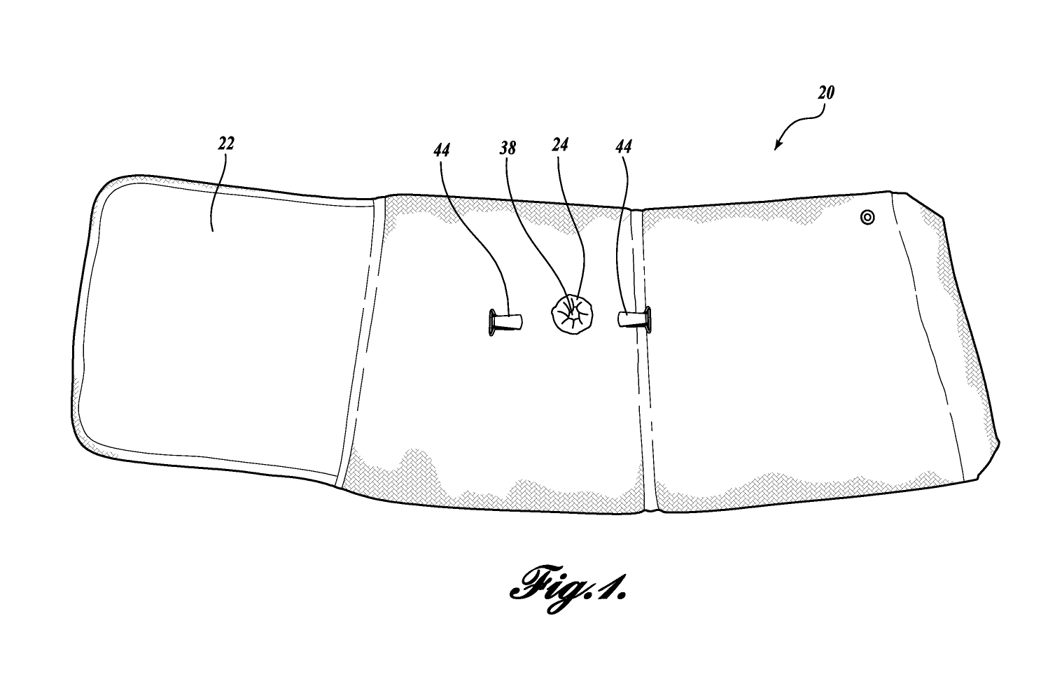

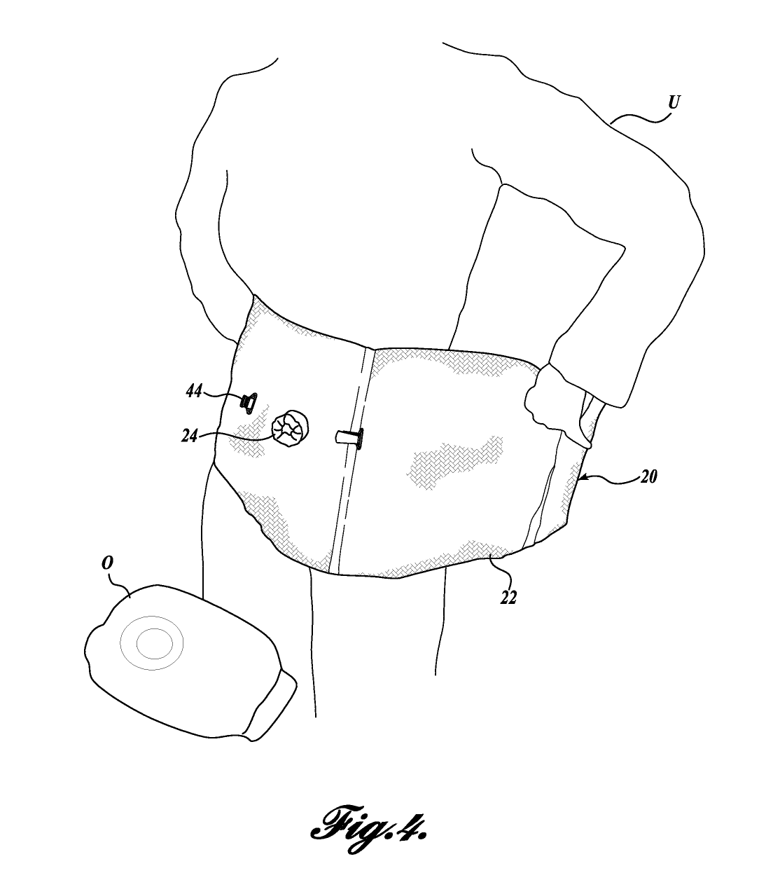

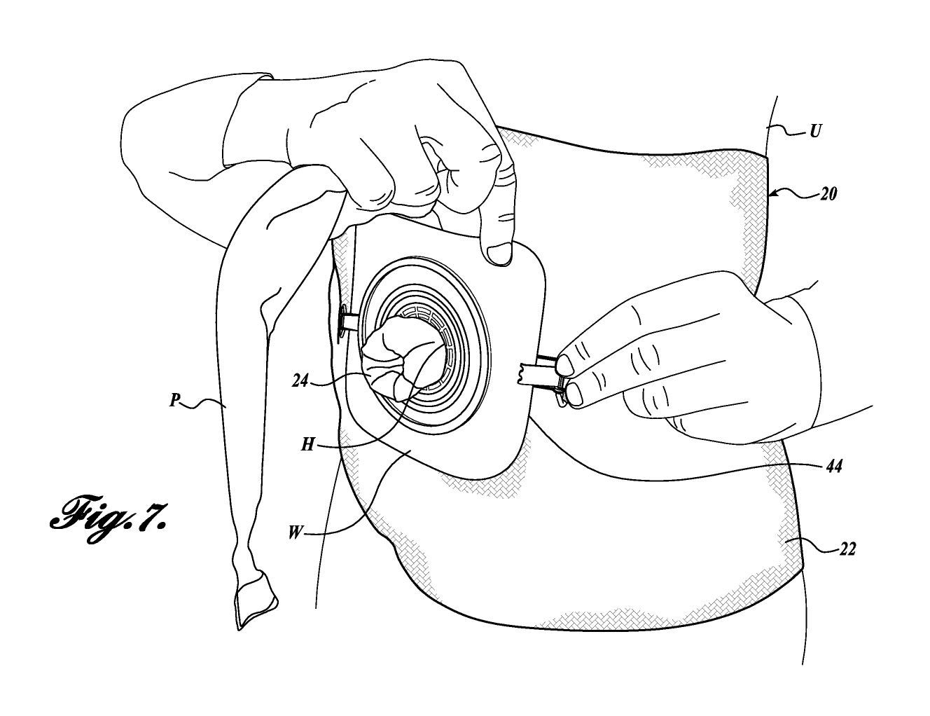

Embodiments of the present disclosure are directed to an ostomy learning assembly. Referring to FIGS. 1-3B, one embodiment of the ostomy learning assembly 20 includes a body attachment device 22 and an artificial stoma 24. The body attachment device 22 is configured to be positioned on a user's body U (see, e.g., FIGS. 4-9), such that the artificial stoma 24 can be accurately positioned to approximate the actual or predicted location of a surgically created stoma on a patient's body after an ostomy procedure.

In the illustrated embodiment, the body attachment device 22 is an abdominal binder that can be wrapped around the user's abdomen and attached using one or more fastening mechanisms, such as hook and loop fasteners, buttons, snaps, etc. The abdominal binder may be attached on the user's body in a suitable position for the user to practice with the artificial stoma.

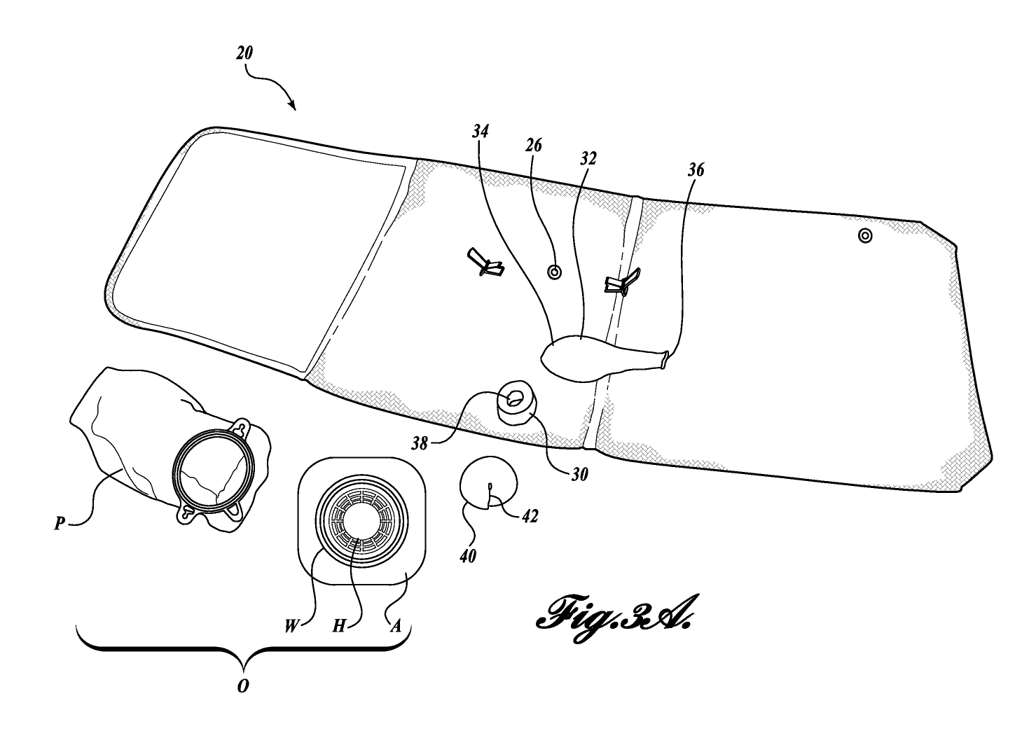

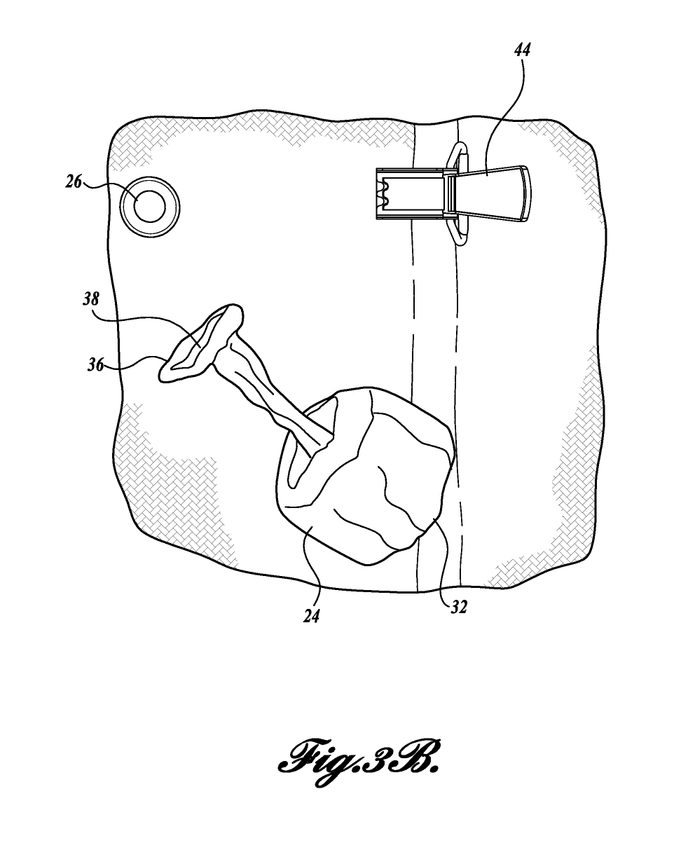

The body attachment device 22 may include means for attachment of the artificial stoma 24, such as a hole 26 (see FIG. 3A). In the illustrated embodiment, the hole 26 is an eyelet hole. However, it should be appreciated that an eyelet is not required to attach the artificial stoma 24. Moreover, a hole is not required to attach the artificial stoma 24. In that regard, other stoma attachment mechanisms and methods are within the scope of the present disclosure, such as adhesive attachment directed to the body attachment device 22, hook and loop attachment, various fastener attachments, etc.

Although shown in the illustrated embodiment as an abdominal binder, it should be appreciated that the body attachment device 22 need not be an abdominal binder and need not wrap around the user's entire abdomen. As non-limiting examples, the body attachment device 22 may be a belt, a wrap, a garment (for example, a pair of shorts, pants, a compression garment, such as biking shorts, etc.), or an attachment patch that attaches to a garment or directly to the user's body. If attaching directly to the user's body or the user's clothes, the body attachment device 22 may include, for example, an adhesive backing as means for attachment.

The artificial stoma 24 extends outwardly from the body attachment device 22 to simulate extension of a surgically created stoma from the patient's body. Because every surgery and patient is different, surgically created stomas may have varying diameters, extension lengths, and body positions. Therefore, the artificial stoma 24 of the present disclosure can be configured to be sized to approximate the actual or predicted dimensions of a specific patient's surgically created stoma.

In the illustrated embodiment of FIGS. 1-3B, the artificial stoma 24 (see FIG. 1) is created using a base 30 and a cover 32 for the base. In the illustrated embodiment, the base 30 is a piece of foam piping. Moreover, in the illustrated embodiment, the cover 32 is a balloon. Although the illustrated embodiment uses a balloon and foam piping to create the artificial stoma, it should be appreciated that other materials may also be used to create a suitable artificial stoma. In that regard, it should be appreciated that the base 30 may be any suitable base that has structure to extend outwardly from the body attachment device 22, and the cover 32 may be any suitable plastic or fabric encasement for the base 30.

Referring to FIGS. 3A and 3B, the piping 30 is inserted inside the balloon 32. A small hole or slit is cut on the bulbous end (or closed end) 34 of the balloon 32 and the air-filling end (or open end) 36 of the balloon 32 is inverted and fed through a center hole 38 of the piping 30 and through the small hole on the bulbous end (or closed end) 34 of the balloon 32.

The resulting balloon-covered piping 24 resembles a surgically created stoma (see FIG. 3B). In that regard, the artificial stoma 24 has a diameter, thickness of stoma wall, feel, and center hole 38 (see FIG. 1) that resembles a surgically created stoma. It should be appreciated that the artificial stoma 24 may be uniquely crafted to approximate the diameter and extension length of a specific patient's surgically created stoma. In that regard, a kit for preparing a unique artificial stoma 24 is within the scope of the present disclosure. The kit may include, for example, a balloon, one or more foam piping pieces of various lengths and diameters, a body attachment device 22 (which may include an optional ostomy appliance attachment system, such as suspender clamps, described below), and a stopping device 40 (described below).

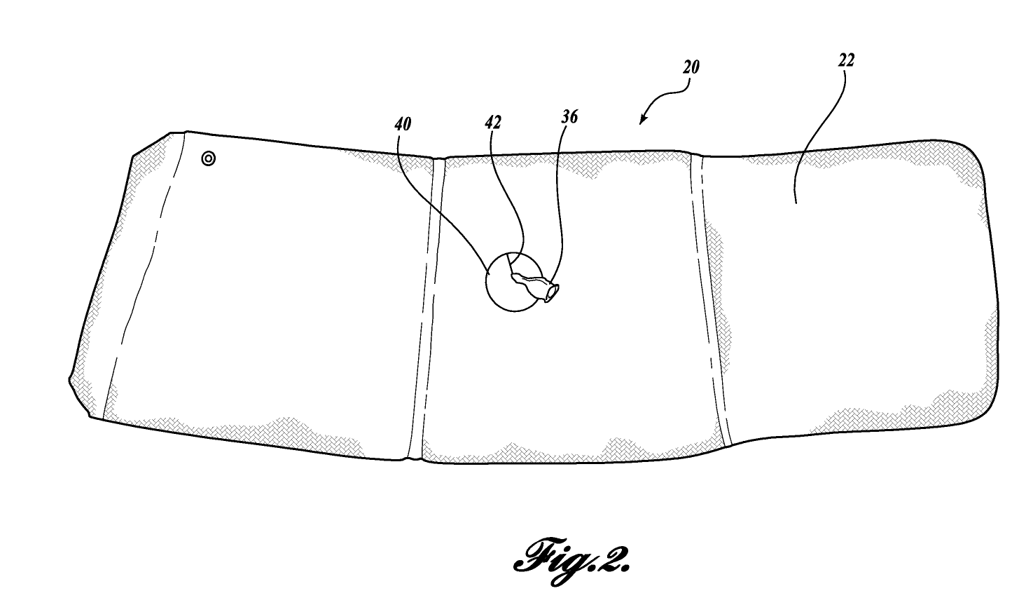

Referring to FIG. 2, the inverted air filling end 36 of the balloon 32 (see FIG. 3A) creating the artificial stoma 24 is received within the hole 26 of the body attachment device 22. A stopping device 40 can be used to maintain the artificial stoma 24 in the hole. In the illustrated embodiment, the stopping device 40 is a cardboard backing piece having a slit 42 for receiving the inverted air filling end 36 of the balloon 32. However, it should be appreciated that other stopping devices may include ties, clamps, or other suitable stops.

Referring to FIG. 3A, the ostomy appliance O includes a pouch P made of a special form of plastic designed for collecting body waste. The appliance O further includes a wafer or base plate W that attaches to the user's body U using an adhesive skin barrier A. Using the adhesive A, the base plate W of the ostomy appliance O can be attached directly to the body attachment device 22.

To prevent the waste of unused ostomy appliances when the user U is practicing with the ostomy learning assembly 20 of the present disclosure (see FIGS. 4-9), the assembly 20 may also be attached to the body attachment device 22 using alternate attachment means, for example, an appliance attachment system 44 (see FIG. 1). In the illustrated embodiment, the appliance attachment system 44 includes suspender clamps. However, it should be appreciated that other attachment systems are also within the scope of the present disclosure, including, but not limited to, buttons, snaps, hook and loop fasteners, supplemental adhesive, and other clamps and clips, such as alligator clamps, etc. Some of the appliance attachment systems may require modifications to the ostomy appliance O, such as using scissors to cut slits or button holes along the sides of the base plate W for receiving buttons.

Referring to FIGS. 4-9, an illustrated method of using the ostomy learning assembly 20 of the present disclosure will now be described. Referring to FIG. 4, the user U obtains an ostomy learning assembly 20 and attaches the body attachment device 22 to his or her body. In the illustrated embodiment, the body attachment device 22 is an abdominal binder, which is wrapped around the user's body U and secured using the integrated hook and loop fastener system.

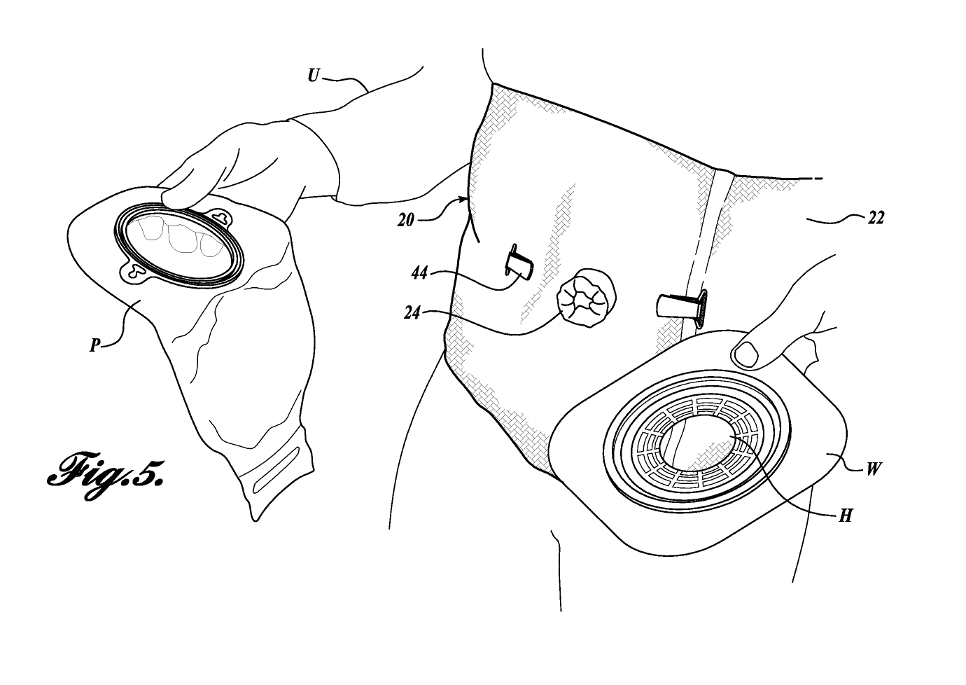

Referring to FIG. 5, the ostomy learning assembly 20 is shown attached to the user's body U, with the artificial stoma 24 positioned to approximate a surgically created stoma. With the ostomy learning assembly 20 attached to the user's body U, the user disassembles the ostomy appliance O by removing the base plate W from the pouch P.

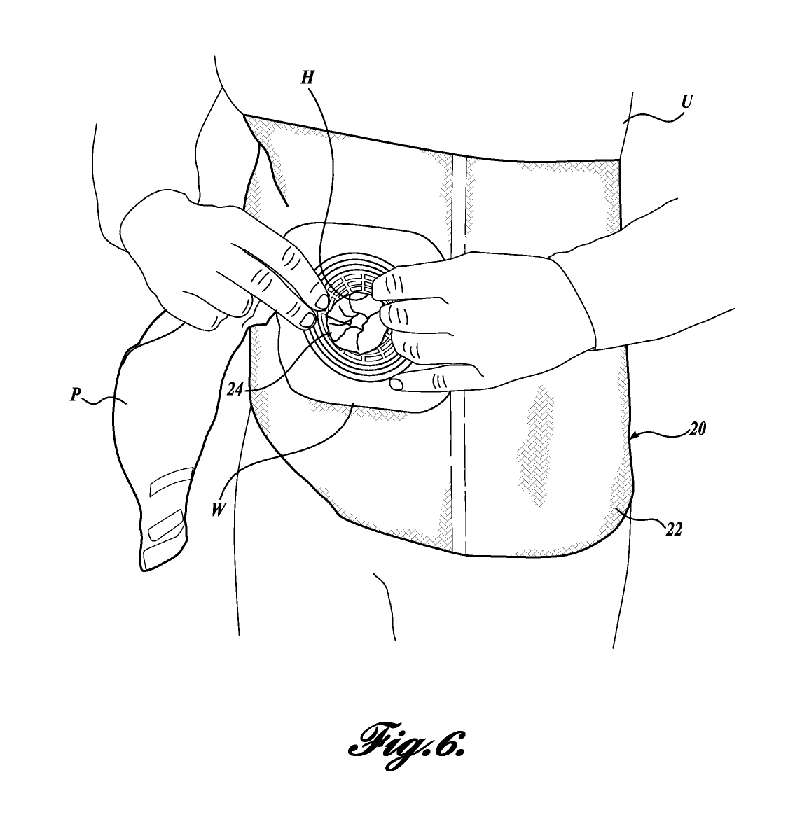

Referring to FIG. 6, the user U applies the base plate W over the artificial stoma 24 with the stoma 24 centered in the hole H of the base plate W, in the same way that a base plate W would be applied to the user's skin in the case of a surgically created stoma. The user U may remove the adhesive backing to stick the adhesive skin barrier A (see FIG. 3A) of the ostomy appliance O to the ostomy learning assembly 20. As shown in the illustrated embodiment, the user U may also secure the wafer W to the ostomy learning assembly 20 using the alternative attachment means, shown as suspender clamps 44.

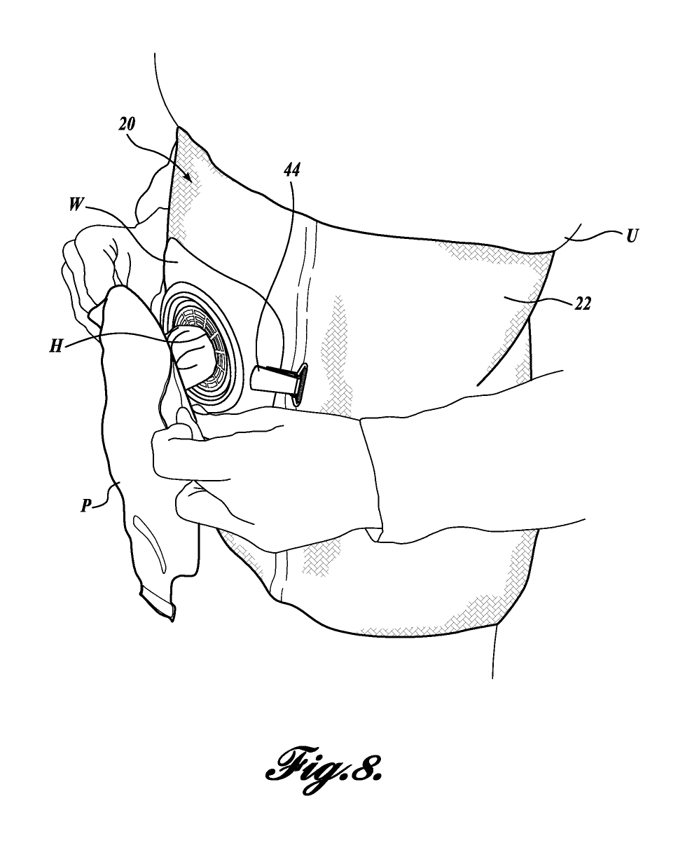

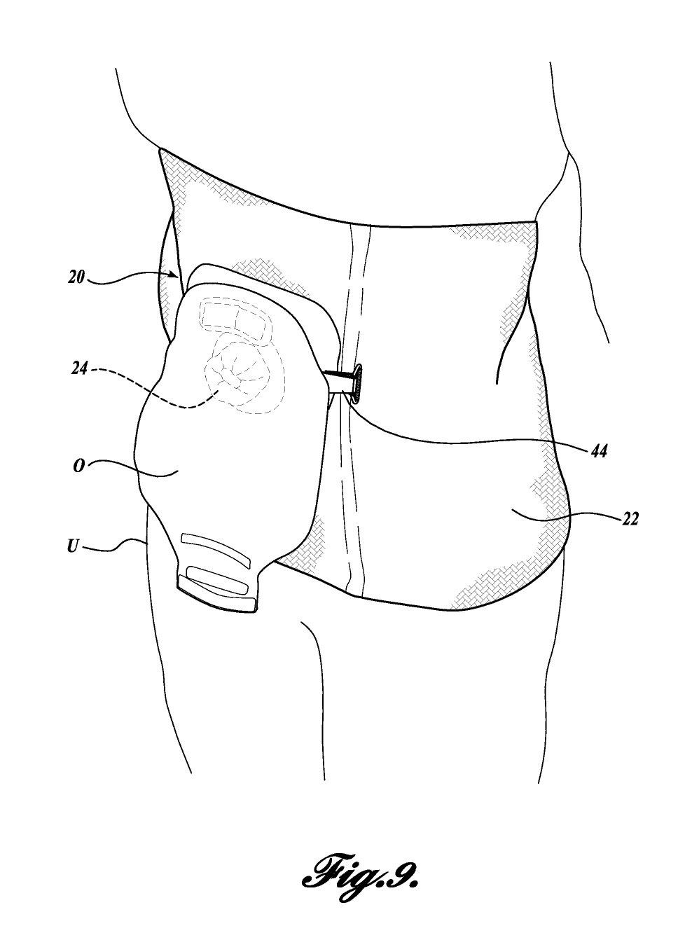

Whether using the adhesive skin barrier A or the alternative attachment means, the ostomy appliance O is positioned on the user's body using the ostomy learning assembly 20 to simulate attachment to a surgically created stoma. Referring now to FIGS. 8 and 9, the pouch P portion of the ostomy appliance O can then be attached to the base plate W.

It should be appreciated that various ostomy appliances O are designed and made by various manufacturers, each having unique features, for example, by companies such as Hollister, Convatec, and Coloplast. The ostomy learning assembly 20 of the present disclosure is advantageously designed to be compatible with all of the various ostomy appliances.

While illustrative embodiments have been illustrated and described, it will be appreciated that various changes can be made therein without departing from the spirit and scope of the disclosure.

1. An ostomy learning assembly, including:
(a) a body attachment device; and
(b) an artificial stoma couplable to the body attachment device.

2. The assembly of claim 1, wherein the body attachment device is selected from the group consisting of a belt, a wrap, a garment, an abdominal binder, and a patch attachment.

3. The assembly of claim 1, further comprising an ostomy appliance attachment system.

4. The assembly of claim 3, wherein the ostomy appliance attachment system is selected from the group consisting of buttons, snaps, hook and loop fasteners, adhesive, clamps and clips.

5. The assembly of claim 1, wherein the artificial stoma includes a base and a cover.

6. The assembly of claim 1, wherein the body attachment system includes means for attachment of the artificial stoma.

7. The assembly of claim 1, further comprising a stopping device to maintain the coupling between the artificial stoma and the body attachment system.

8. A kit for making an ostomy learning assembly, the kit comprising:
(a) a body attachment device; and
(b) an artificial stoma including a base and a cover that is configurable by a user to approximate the actual or predicted dimensions of a surgically created stoma, wherein the artificial stoma is attachable to the body attachment device.

9. The kit of claim 8, wherein the artificial stoma includes a balloon and a piece of foam piping.

10. The kit of claim 8, further comprising a stopping device.

11. The kit of claim 8, further comprising an ostomy appliance attachment system.

12. A method of practicing attaching an ostomy appliance to an artificial stoma, the method comprising:
(a) obtaining an ostomy learning assembly including a body attachment device and an artificial stoma;
(b) attaching the body attachment device to the body of the user;
(c) positioning the artificial stoma in the approximate location of a real stoma; and
(d) attaching the ostomy appliance to the artificial stoma.

13. The method of claim 12, further comprising attaching the ostomy appliance to the body attachment device.

14. The method of claim 12, further comprising attaching the ostomy appliance to an ostomy appliance attachment system.

15. The method of claim 12, further comprising sizing the artificial stoma to approximate the actual or predicted dimensions of a surgically created stoma.

16. (canceled)
